(19) United States
(12) Patent Application Publication
(10) Pub. No.: US 2006/0155755 A1
(43) Pub. Date: Jul. 13, 2006

(54) Constructing and referring objects in a computing environment

(76) Inventor: Erez Elul, Givataim (IL)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/258,050

(22) PCT Filed: Apr. 17, 2001
(86) PCT No.: PCT/EP01/04354

§ 371 Date: Nov. 24, 2003

(30) Foreign Application Priority Data
Apr. 17, 2000 (EP) 00108378.1

(51) Int. Cl. G06F 17/00

(52) U.S. Cl. 707/103 R

(57) ABSTRACT

A system of constructing, referring and manipulating new types of uniform, strictly defined and generically connective objects in computing environments, allowing identification, connection, insertion and re-definition of fully as well as partly defined objects and providing a new self-organizing, open computing space for referring these objects in several independent tree Ostructures, so that the system, its constructed systems, scopes of connections and objects all share the same space lifetime. The invention provides a new approach and architecture for building structures of objects, useful for generic knowledge systems, interactive and automatic language processing and other applications requiring automatic next order processes and global referring in deterministic and non-deterministic environments. The invention also provides a method to develop tools to adapt computer systems to the logic of specific users.

### BACKGROUND OF THE INVENTION

This invention relates to three central issues of computing:
the global referring of objects in computer systems and networks,
the adaptive properties of computers and software in relation to users,
the capability to automate and to continue next higher order processes,

These issues have been at the center of research and development since the invention of the computer. To this day, computing is severely limited in all three areas. There are many attempts in prior art to solve some of them separately or in isolated development ‘bubbles’ of highly specialized applications. Most of these attempts have concentrated on algorithmic approaches, providing better and more complex algorithms to overcome limitations considered as given by the underlying architecture of computing. This architecture, however, has not been altered considerably, at least not in a general and systematic way and is still the foundation of all major operating system platforms. The invention considers his architecture to be the main cause for the limitations mentioned above. They are:
Current computer architectures provide very limited access and orientation in their referring and data spaces in general and specifically in non-deterministic data spaces and object bases, like the Internet, where not all elements are known or fully defined. Generally, no global and direct data-to-data is provided in prior art. It is the object of the invention to generically provide direct data-to-data access as well as a method to identify objects which are not fully defined and thus to enable orientation in non-deterministic systems.
Computers today require the user to predefine both the satisfactory fulfillment of the task of an operation and the initialization of the operation itself. These predefinitions in turn require a predefined user, provided in prior art as the statistically pre-defined ‘common user’, and force the specific human users to adapt to this statistical model. Prior art computers can principally deal only with this ‘common user’, leading to an overemphasis on ‘user friendly’ gimmicks that bloat software without being able to adapt to specific users. It is the object of the invention to provide a method to develop computer systems that can indeed adapt to the logic of specific users.
Closely related to this issue is the automation of tasks, or, as it is also commonly called, the ‘intelligence’ of computers. The key topics here are ‘insertion’ and ‘next higher order’ processes. Computers today generally offer a low degree of automation, no continuous next order processes and extremely limited insertion. These general limitations are considered to be mainly responsible for the failure of the ‘Artificial Intelligence’ (AI) project in computing. Both prior art ‘AI’ approaches, ‘top-down’ AI and ‘bottom-up’ (Artificial Neural Networks) have not been able to deliver generic, simple and programmable methods or tools solving these problems. It is the object of the invention to provide a method to increase the level of insertion beyond prior art and to facilitate automatic next higher order processes with decreasing human intervention to redefine next steps, eventually, in future embodiments of this invention, allowing automatic programming and related applications.

### DESCRIPTION OF RELATED ART

There are many methods known in prior art which attempt to overcome some of these limitations. They illustrate not only the problems which need to be solved, but also the different approaches in prior art and in this invention. Most prior art solutions attempt to selectively overcome some of the basic limitations of hierarchical structures such as access, search and navigation in trees, without, however, changing the underlying architecture. One such method is “Access Support Relations”, suggested as an “Indexing Method for Object Bases” by Alfons Kemper and Guido Moerkotte in a 1992 paper of the same name. It maintains “separate structures (disassociated from the object representation) to redundantly store those object references that are frequently traversed in database queries.” To achieve this, an object-oriented new “Generic Object Model” (GOM) was suggested, which does not represent data, but rather acts as a container of references to a data object, stored separately in another structure. Another approach (Steven P. Nickel, U.S. Pat. 19890414045 19890928) uses prefix indexes in nodes of tree structures to better refer data records.

Yet another approach (Simon Williams, U.S. Pat. 19980108078P 19991112) provides a data management architecture that associates data records and relations with unique identifiers and records data and their relations in separate hierarchical structures.

All these and similar methods and systems use additional and external attachments to traditional data objects. The approach of the invention is fundamentally different. It provides first an architecture and mechanism to systematically break hierarchical structures at every computing step. It achieves this by well balanced and integrated elements, rules and orders, ranging from the exclusive use of novel, strictly defined, uniform objects representing as well as referring the represented data objects in any numbers of separate, yet integrated hierarchical structures as well as in a dimensional scale of unique identifiers. The main paradigm of the invention is to record data not in the traditional set theory or object oriented way as ‘containers’ encapsulating the represented data information, but as connections. The ‘connective objects’ of the invention are several identifiers grouped together and related by mathematical equations, thus behaving like executable code. The system of the invention records these ‘connective objects’ into an open, ‘meta-hierarchical’ space, where all objects share the same lifetime. The term ‘meta-hierarchical’ refers to the property of the system to integrate more than one independent hierarchical trees, to achieve non-liner effect like setting new beginnings as roots in any point of its structures without requiring the structures to be rebuilt, and automatic next order processes. In the self-organizing, non-linear connection space of the invention data are constructed primarily just from connections.

Traditional data arm represented in the system of the invention as sequences (‘wholes’) and sub-sequences (‘parts’) described by the connective objects of the system. All possible (or desired) sequential combinations of such sub-sequences are available for reconsruction of whole sequences or for re-combination into other sequences, together with sub-sequences of other data.

Such a system, although highly desirable, has been considered incomputable up to now. The reason is, that the combinatory information required to connect sub-sequences or parts is based on a known formula from the German mathematician. Gauss, leading to exponential growth of the combinatory information with increasing number of parts. One of the main achievements of this invention is to provide not only a method to dramatically compress these combinatory information, but also to automatically scale connectivity based on punctuations it recognizes in the data sequences. For example, text data would be recognired as such and not connected on a letter-to-letter basis, but rather on a word-to-word and sentence-to-sentence basis. The paradigm of the invention is to provide data parts with their possible connections, and to globally access all these parts and connections. Every part only exists once in the system, so compression of required storage space is increased as more parts are recorded to the system. Again an example from word processing: once a system of the invention has recorded all possible words of a language (as well as many different combinations of those as sentences or parts of sentences), it would be able to produce new texts just by recombining the existing parts.

Another unique feature of the system of the invention is its capability to perform next orders of its objects and the parts referred by its objects in a continuous process. Since the system uses only small uniform objects that are fully self connected and can refer data parts of any size, the system can form next orders not only of words or short queries, like in prior art search engines or dictionaries, but can also form next orders of all its parts (like sentences or other data sequences) regardless of the size of these parts. The system of the invention can perform such operations without running into size problems, and will be able, in respective embodiments, to translate sentences from one language into another language based on knowledge about the use of these sentences in both languages. This allows new generations of language and speech processing systems.

The ‘connective objects’ of the invention are not objects in the object oriented sense containing or encapsulating the represented data. The invention objects consist mainly of several combined identifiers and only exist as objects (holding a Global Unique Identifier) when they have the identifiers of all of the at least 2 hierarchical structures of the system. These connections are conditions of every object's existence, not external attachments to an already existing object. The invention objects are not only generically connected to all the structures of the invention system, but also to other invention objects, so touching one starts a chain reaction leading to others. These features constitute a fundamental difference to and departure from prior art objects. It is precisely this new object type, always strictly defined, uniform and by definition self-connected in more than one hierarchical structure and additional in one dimensional structure, that allows, together with the invention's mechanism for systematically differentiating and unifyg all connections of an object at every step, global access to and global referring of all objects (connections, relations, orders etc.) of the system, to perform next higher order processes, and to adapt to logics outside of the system. While the prior art inventions and methods cited here all relate to database management and database architectures, and are restricted to referring—‘associatively’ or otherwise—of predefined, ‘tagged’ and indexed traditional data objects, the invention provides a generic open, indexless referral system for all computing activities. The invention in fact creates a ‘bottom-up’ standard unifying all computing activities, because the objects of the invention can describe all such activities, including data, connections, program code, orders and standards, without needing a top-down meta-standard.

### SUMMARY OF THE INVENTION

An object of the invention is to allow constructing and referring objects in a computing environment.

The present invention comprises the features of the independent claims. Preferred embodiments of the invention are defined in the dependent claims.

The invention provides a novel system and space for global referring of a new type of generically connective and insertable objects, allowing high level manipulations, like automatic next order processes, including adapting to logics outside of the system.

Inclusion and Connection

Referring of objects in prior art computer systems is generally based on hierarchical structures. Since the layers of these structures are only accessible when active, referring is principally limited and difficult. Prior art uses methods for constructing or connecting objects that usually are within the “object oriented” paradigm or generally are methods derived from the “traditional theory of sets”. Based on both, prior art constructs and connects generally by building hierarchical structures of inclusion in scopes, using identifiers in such a way that the addressing of the constructed objects is exclusively a result of determination external of the addressed object. According to set theory, the primary definition of connection is based on inclusion, so that elements are connected together with each other, if and only if, they are included together in a set. Inclusion, however, is only one specific conditioning case of connection. The reverse characterization of inclusion based on connection is not possible in prior art. The invention does exactly that, so when the included is the connected, which is conditioned by the including, the connected which is not conditioned is not included, but still connected. By this characterization, prior to condition there is always connection, because being included is a specification of being connected. The difference between prior art and the invention thus can be summarized in one simple sentence: all of inclusion does not include all of connection, but all of connection connects all of inclusion.

Suppose ‘A’ is an element in a set ‘B’, then ‘A’, which is included in ‘B’, does not include ‘B’. But suppose ‘A’ and ‘B’ are connected, then ‘A’, which is connected to ‘B’, connects ‘B’. In the first asymmetric case, ‘A’ and ‘B’ are conditioned asymmetrically, because when ‘A’ is included in ‘B’, then the reverse statement “‘B’ is included in ‘A’” is false, and because when ‘B’ does not exist and ‘A’ is included in ‘B’, then also ‘A’ does not exist. In the second, symmetric case, both statements “‘A’ is connected to ‘B’” and “‘B’ is connected to ‘A’”, are true, and when ‘B’ does not exist and ‘A’ is connected to ‘B’, then ‘A’ can exist.

Set theory is considered here also as a hierarchical system of connecting and naming, since the theory connects one set to several elements, all being equivalent to an hierarchical layer. By those distinctions the main limitation of set theory and of the prior art systems based on it appears as the limitation of ‘asymmetrical’ versus ‘symmetrical’: Being included constitutes only an asymmetrical specification of being connected. The following specifies these limitations:

Lifetime, Traversing Trees and Global Access

Prior art restricts connection just to the condition of inclusion, thus hides all the connections prior to that condition. This hidden part of the connection is also well demonstrated in the fundamental problem of hierarchical structures, structured by asymmetrical conditioning. While in a structure of two-dimensional points, ‘A’ and ‘C’ can be connected by going through point ‘B’, or directly, bypassing ‘B’, in hierarchical structures bypassing ‘B’ is ill defined, when ‘A’ conditions ‘B’, and ‘B’ conditions ‘C’. In prior art, this problem of traversing trees is partially solved by additional pointers used as ‘shortcuts’. Those pointers, however, do not have the property of what they point to and are not globally available. They are also not visible to the hierarchical structure and to the object they point to, creating problems when objects are moved in the structure, and in general adding to the complexity of structures. The invention generally enables traversing trees by connecting all of its objects simultaneously and necessarily in two or more independent trees and also uniquely in a dimensional structure, all sharing the same lifetime.

‘Lifetime’ in hierarchical structures is the time during which an object is ‘active’ or ‘alive’ in its active scope. Access is only provided during this lifetime, enabling referring and making the object valid. Without the ability of referring, an object is ‘ill defined’. The lifetime providing access of prior art objects is defined by their scopes, therefore bypassing scopes of objects is also ill defined. Although this problem can be reduced in prior art by constructing paths of layers of conditions of inclusion, or of layers of characterizations, this alone does not provide global access. Global access of all objects of an hierarchical system is required when all objects, connections and scopes (contexts) of a system or of a network need to be available, as in language computing, data mining or complex search operations in unstructured or semi-structured environments (like the Internet). To be able to do this, one must be able to bypass all layers and traverse all sub-trees, yet the layers of hierarchical systems of prior art are in different scopes with different lifetimes. Only when all scopes of the system have the same lifetime, can the system fully refer all of its objects, and only then bypassing of any of the objects and connections is available. In prior art, like the Internet, additional non-hierarchical structures like dimensional scales of global unique identifiers are employed to ease data access. These systems generally do not, however, provide direct data-to data access, but only access to containers (HTML pages, files, documents etc.), which again are structured hierarchically.

The invention provides a system that allows to refer all of its objects in all scopes of various trees, all sharing the same system lifetime. Since it conditions by connections, not only by inclusion, and also prior to inclusion, it defines scopes of connections and scopes connected or not connected to other scopes having the same lifetime. It connects and identifies and constructs within and between all scopes of the entire system, since all scopes have the lifetime of the system.

Insertion Level

As long as an operation is initiated ‘outside of itself’ or fulfilling its task to a satisfaction defined ‘outside of itself’, the well defined distinction of the operation, based just and only on the distinction made up by inclusion, can be made only, when that ‘outside-of-itself’ is predefined. That is why prior art requires predefinition of the satisfaction of the task fulfilled by the operation as well as predefinition of the initialization of the operation. The hierarchical form of addressing can distinguish very well the specification from the generalization of the addressing. This quality, together with the quality of the dimensional form to unify specification and generalization, are used to limit the pre-definition problems. This limitation of the predefinition problems being related to all possible objects being uniquely identified, can be measured as follows:

When a dimensional structure in its scale of unique identifiers uniquely identifies all the possible objects being identified also by an hierarchical structure sharing the same lifetime of the dimensional, and when that same lifetime enables bypassing, then the ratio of the smallest scale of any layer of the hierarchical structure to the scale of the dimensional structure can be called the ‘level’ of the insertion.

The insertion is measured by this level as an insertion of any possible object to be an ‘outside-of-itself’ intended to be inserted into the layer of the object. This level corresponds to the one lifetime of the range of possibilities being the specification distinguished from the generalization. The higher this ‘insertion level’ is, the less the ‘outside-of-itself’ is required to be predefined. This ‘insertion level’ can be applied also to operations in a system.

Although prior art provides solutions by constructing specification and generalization of addressing in a form of a pointer to be distinguished or unified by lifetimes of scopes, its maximum insertion level is always one, such as in the standard notation for an address in the memory (RAM), which takes the form ‘segment:offset’, when the ‘segment’ (base addresses) and the ‘offset’ have different lifetimes, or in the hierarchical form of ‘directories’ addressed also by unique dimensional form of addressing in the hard disk, when both forms of addressing designing the form of the hard disk share the same lifetime.

The invention's method of constructing addresses uses the numerical base technique, because this technique allows to apply a referring system in hierarchical form to a number in dimensional form, thereby achieving one lifetime in both hierarchical and dimensional structures with the insertion level of one (maximum of prior art) as the minimum of the invention (with a predefined maximum). The level of the insertion is determined by the number of the digits corresponding to the number of the special pointers of the invention, constructing a path to the object of the invention, instead of just one such digit used in prior art. The digits are of an equivalent number being a property (and not an attribute) of the addressed object, when the used digits in their locations of numbers construct the addresses of the invention object, and the unused digits construct the ‘defined void’ addresses of the object. Both the used and the unused digits provide the ‘outside-of-itself’ defined by the insertion level as the ‘defined void’ addresses, which are intended to be inserted as object addresses.

Number of Objects and Inclusion of Domain

In prior art, when a domain includes another, both being domains of objects having identical size, the included has less objects then the including domain, whereas in this invention a domain including another has not just objects but also potential objects (‘defined voids’), so that the included domain (in hierarchical layer form) defines ‘insertion level number’ times more objects and potential objects than its including domain (in dimensional form) does. Furthermore, prior art distinguishes absolutely between the address of the object and the object itself, corresponding to the inclusion logic of the ‘traditional theory of sets’. Therefore, prior art pointers have only the address property of the objects they point from and not the property of the objects they point to, so prior art does not, as the invention does, have an external domain belonging to the addressed object which determines the addressing specification of the object in both the included and the including domains.

Domains and Using Dependency and Independency of Identifiers

Prior art unifies laws of orders determined by sizes of ranges to be equal or smaller than the including ranges, activated in scopes defining lifetime of their objects, so that the object shall be uniquely identified for being accessed. Thus, when the objects have one common lifetime, the insertion level necessarily is smaller than one. The invention constructs two equivalent types of laws of order: the global order in the including domain constructed by a global unique identifier, and the scopal order constructed by two or more different types of scopal identifiers: the ‘outer identifier’, defining the included domain and the ‘inner identifier’, identifying in the included domain. Any of the three (in the preferred embodiment, or more in other embodiments) identifiers independently constructs a domain of objects, while only the equivalences of the three (or more) construct an object address. The domains of objects refer to totalities which can but don't have to be identical or connected and all the invention laws of order, identifiers, objects and connections share the same lifetime.

Dimensional Form Hierarchical Form and New Beginnings of a Form

Prior art distincts between dimensional and hierarchical forms of addresses, whereas this invention unifies dimensional together with different, yet coexisting, hierarchical forms of addresses, so any object attributed by several addresses is ‘crossed’ by the forms of these addresses. The invention first replaces ‘inclusion’ with ‘crossing’ for relating forms constructing objects and then can separately set precedence(s) between the crossing forms, after which any such precedence corresponds to a form of inclusion of forms defining its beginning or root. The invention thus enables methods to set the beginning of their forms corresponding to all the invention objects together with their input/output forms, such as the beginning of the form being the data scope form starting in an invention object, and in the data scope the beginning of the form set as invention object being input or output forms, or being ownership, or being identical combination of figures upon their locations etc. This property of the system to allow setting new beginnings as new roots anytime and anywhere in the system, is another fundamental departure from prior art, which, since it is based on set theory architectures, requires generally to start at one predefined root and to continue searching the established tree structures until reaching the requested node.

Objects and Connective Objects

Prior art distinguishes between objects and connection of objects, in the limitation of the forms of the objects. ‘Objects’ in prior art are generally treated as ‘containers’ encapsulating the represented data or code. According to this paradigm, objects can have very different sizes. They are connected by attaching attributes of connection like identifiers, tags, metadata etc. The invention object is a ‘connective object’ defined to be generically self-connected as a connection of objects sharing the same lifetime of the object itself. It does not, like prior art, require external identifiers, tags or metadata. It is also not a container of traditional encapsulated data or code. The object of the invention consists mainly of several identifiers (qualifiers, pointers) which are strictly defined. The object of the invention may also hold values, but not in the sense of prior art, encapsulating represented data. When an object is not used as a connection of objects, then its address is a connection. If the address shares the lifetime of the object then it or the object is a connective object. If the address shares lifetime of the structure containing it as well as of other structures too, then the object is connective in the invention sense. This applies to one-dimensional, multi-dimensional and traversing tree structures.

Data and Recording

It can be said that data is whatever a system records and afterwards recalls or constructs to the satisfaction of the user. Data can be recorded and reproduced in different ways. One is representation by digital description languages, another by analog representation (as in photography), yet another by literary description. Our brains have long been thought to record data by methods similar to photographic representation of the ‘outside world’, until neuroscientists argued that the brain neither has a data storage device that could store the amount of data that our sensory cells transmit as signals in response to environmental stimnuli, nor does it have a logic mechanism or ‘master brain’ to interpret such representations. All that scientists can find is an active switching mechanism (synapses) as part of a complex network of neurons. Unlike in current computers, there is no data storage for representations to be found in the brain, and thus no ‘memory’ in a computing sense. Data are constructed by a complex mechanism of connecting and re-connecting in an associative connection space in ways currently not known in any detail. The invention uses a similar metaphor and analogy for recording and producing data in computers. It constructs a ‘live’ network (having system lifetime) of connections (invention objects) that do not contain traditional data, but can describe and refer, and thus construct and reconstruct, data in the traditional sense. Data in the invention system are constructed exclusively by referring, so that the invention can be described as a system of referring connections or of ‘connective objects’. The variety of connections available in the system of the invention indicates its flexibility and wide range of usage.

Variety of Connections

The number of different types of connections of ‘connective objects’ is defined here by the minimum equivalent number of different or separate structures of inclusion required to include these objects. This number corresponds to the variety of connections crossing a ‘connective object’. Since prior art determines itself by inclusion, and since lifetime is restricted there to a scope, this number in prior art is always one, whereas in the invention this number is constructed for at least two different types of connections: for one dimensional type this number equals one, and for the other types the minimum of this number equals two, as described above. Together with the insertion level applied to the invention variety of connections, the invention ‘connective object’ is crossed by symmetric (bi-directional) forms of addresses versus the prior art using asymmetric (unidirectional) forms of addresses.

Limitation of Insertion

General attributes such as ‘logic value’ (true/false), decision, activity and data as defined in prior art are ‘connective objects’. Generally, insertion is limited to the insertion level of the ‘connective objects’ available in one lifetime, and also by minimal variety and mostly fixed precedence of the connections of these ‘connective objects’. Additionally, insertion is limited by inclusion logic applied to such general attributes: since the including conditions the included, the already defined precedence necessarily also determines precedence of the applied general attributes such as ‘logic value’ prior to decision prior to activity prior to data, and when the objects connected to these ‘connective objects’ being the general attributes set in such a predefined precedence, then this predefined precedence applies also to precedence of the connection of these connected objects.

Insertion in prior art is not only limited to an insertion level of max one and to a lifetime restricted to a scope, but also by inclusion unifying connections with fixed variety and definition generally tied to what is described above. Prior art can be improved by the methods of the invention, which set precedence while still having their ‘connective objects’ share one lifetime, expand the insertion level of the ‘connective objects’ and provide more varieties of connection because their connections distinct and unify inclusion, so the ‘connective objects’ are crossed by mutual forms of connections.

Open Connection Space and Next Orders

When manipulation of objects includes their construction, removal or insertion, then it is only available in the space where they are ‘connective objects’. Definition of this space is a condition for defining ‘connective objects’ in relation to their potential for manipulation and connection. Since any object of the present invention is a ‘connective object’, uniquely identified by a one-dimensional integer, an existing manipulation argument in the invention space is an integer that can be applied to all the ‘connective objects’ of the system. This constitutes a generically open space in the sense of connection and manipulation. The open connection space of the invention is designed for high level generic manipulation as the next orders of the space of activities, when the insertion is redefined as the ‘next order of activities’ by and as a scale of insertion into interrupted continuous activity being the previous order, with the first order as continuous activity being an order empty of activities, and when every insertion interrupting continuous activity creates the next (a new higher) order.

Prior art limits insertion also by permanently distinguishing between identities and between ‘logic values’ of connections of identities and the identities themselves and also between different scales of their next order of activities such as data next to executing next to logic values like program variables in either linear or non-linear (considered as hierarchical) paths.

Fields of Applications

The system of the invention provides qualities and tools that are highly desirable in many different fields of applications:
1. Global referring (any system object can be addressed and can address any other)
2. Global changing of priorities of connecting (any system object can be prior to any other in any order of connection)
3. Global insertion (any system object can be inserted into any connection of system objects)
4. Uniform objects (strictly defined with defined size)
5. Global unique identifier for every object, self connecting in at least two independent hierarchical structures
6. Global visibility (of any object from any object)
7. ‘Things’ (one or more objects or defined by one or more connections)
8. ‘Void Things’ (a ‘Thing’ but not an object, taking no capacity)
9. Reaction/insertion: turning any Void Thing into an object (global referring and global changing of priority of connection can also be applied to Void Things)
10. Integration of several independent hierarchical structures in any connection
11. Symmetric (mutual) connections (every object visibly points to and is pointed to by others)
12. Flattening of hierarchical structures (linearized on ordered global unique identifier scale)
13. Elimination of complexity (defined by dependency and depth, when the top layer is more complex than the bottom layer and the degree of complexity depends on the depth)
14. Combinations of identifiers defining connections of the owners
15. Next orders of connections (when the owner is an object, the second order of the connection is provided)
16. Connections defined by equations (unique identifier being one side of equations)
17. Standard levels (unique identifier defined in specific or common parts of the system, when the common is identical in other systems)
18. High efficiency of manipulation (size of argument of any combination of identifiers is the size of addressing one object in all the system and between common parts of different systems. No size restriction for input/output arguments to/from the system)
19. Simple and few transformations required to interpret the data model between the machine and the user (the number and the complexity of those transformations can be used to compare data models).
20. Automation, integration and next orders available for all and by all, or parts of all, features, fulfilling all requirements for an open system in terms of connection.

These features of the invention enable future applications to solve some of the most pressing limitations of current computing, like automation, next order processing (as in natural language dialogue), orientation in non-deteministic systems and adaptive man-machine interfaces. Application fields like knowledge systems, pattern recognition and—discovery systems, data mining, language computing, bio-informatics, robotics, hardware design, system simulation, curve prediction, to name but a few, can profit directly from the invention. The system can also be embedded in hardware applications like chip design, communication devices and parallel computing.

Further features, objects and advantages of the invention will be apparent from the following detailed description of sample embodiments in connection with the appended drawings.

### BRIEF DESCRIPTION OF THE DRAWINGS

FIG. 1 Notation and symbols of the system as used in the drawings:
A: Scope (layer) of the ‘normative’ hierarchical structure of the system, connecting one parent object as apex of the open triangle to many child objects at the base. The form of the drawing is referred to as a “fan”.
B: Notation of connections in the ‘associative’ hierarchical structure of the system. The curved arrow goes from a ‘mentioning’ object being an associative child, to a ‘mentioned’ object being its ‘associative parent’.
C: Many-to-one connections of the ‘associative’ hierarchical structure of the system
D: Dynamic insertion
E: Input argument ‘Ia’ symbolizing input to the system
F: Connection between two parents referng by link symbolizing a ‘sharing connection’.
G: Symbol of a connection of an object in the circle having exclusive value ‘Ev’ pointing to the object at the end of the curved line.
H: Exclusive value as calculated data without connection.

FIG. 2 Global Unique Identification Structure with three objects A, B and C

FIG. 3 Equations of identifiers make connections; Example of objects A, B and C.

FIG. 4 Input connection: connecting an Input argument (Ia) to an object C in the normative tree of the system as a new beginning of an associative tree.

FIG. 5 Sharing connection: the child objects C and D share two normative parents A and B. Cp: Combinative pointer

FIG. 6 Connecting object D as ‘associative parent’ shared with R to child objects M, Q and K.

FIG. 7 Bitmap of the object of the invention showing base and offset of all 4 identifiers: ‘Matching identifiers’ Oi and Ii, Private characteristic Pc, being either an Exclusive value Ev or Combinative Pointer Cp, and Unique identifier Ui having its most significant bit (MSB) marking the system variation. The least significant bit (LSB) of identifier Oi is signed. Cp has its MSB unused.

FIG. 8 Two objects (A and B) of the system referring by their Cps to a third object C, also referring to a layer of objects (containing C) in a different tree. The layer is defined as a base in a different subsystem by the linear structure in which the other object refers to the offiset, together by one subsystem defining C.

FIG. 9 Two-dimensional representation of one sub-system, where x is the base of Ui and y is the offset of Ui. The diagonal line represents the Cp values, any of each being a link of a layer of two trees, each layer represented as a perpendicular line. Any object (such as C) is defined by the crossing of these two lines (layers) and as a parent refers to another point in the diagonal line. Any such referring constructs a two-dimensional connection of the perpendicular in a next higher order (new dimension).

FIG. 10 Four sub-systems in a linear structure defined by four trees

FIG. 11 Dynamic insertion modes of the system. A is a static mentioning object. B is a ‘mentioning bypass’ object on the negative side of the normative hierarchical layer's address space (−1*2 [symbol] (x−2) ) and is prior to C-J. C-J are dynamic domains: C: lead domain, dynamic, but in the foreground of the static; D: similar domain in the background of the static; E: latter domain, added after the static; F: contary domain, added instead of the static; G: former domain, added before the static; H: conditioning domain, dynamic under condition of the static, formulated by dynamic=fimction of static; I: conditioned domain, static, under condition of dynamic, formulated by static-function of dynamic; J: last domain, finishing if enabled.

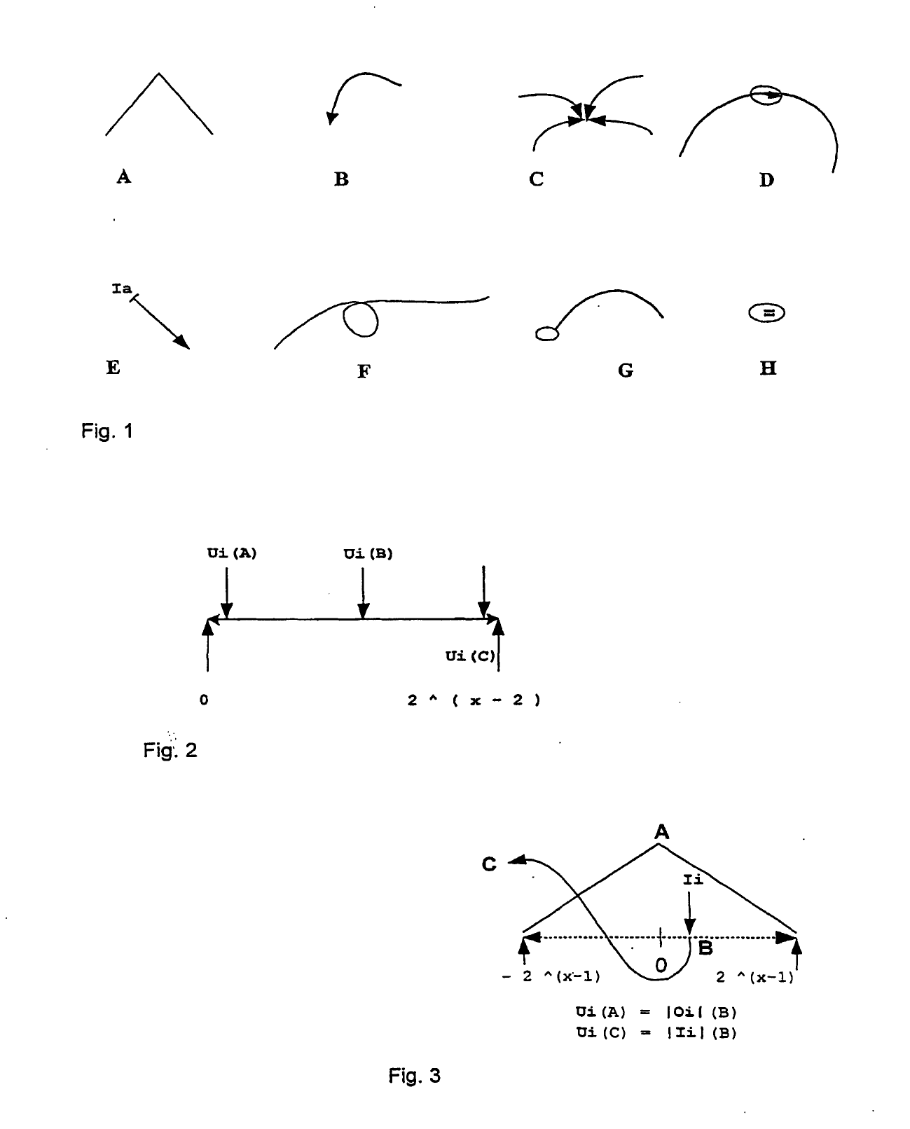

FIG. 12 Data features of the system: crude data case.
A: Input data parent (N=0);
B: crude figure=input argument Ia;
C: parent of crude objects (N=0);
D: crude object (N=1).
N: number of represented data objects, such as B

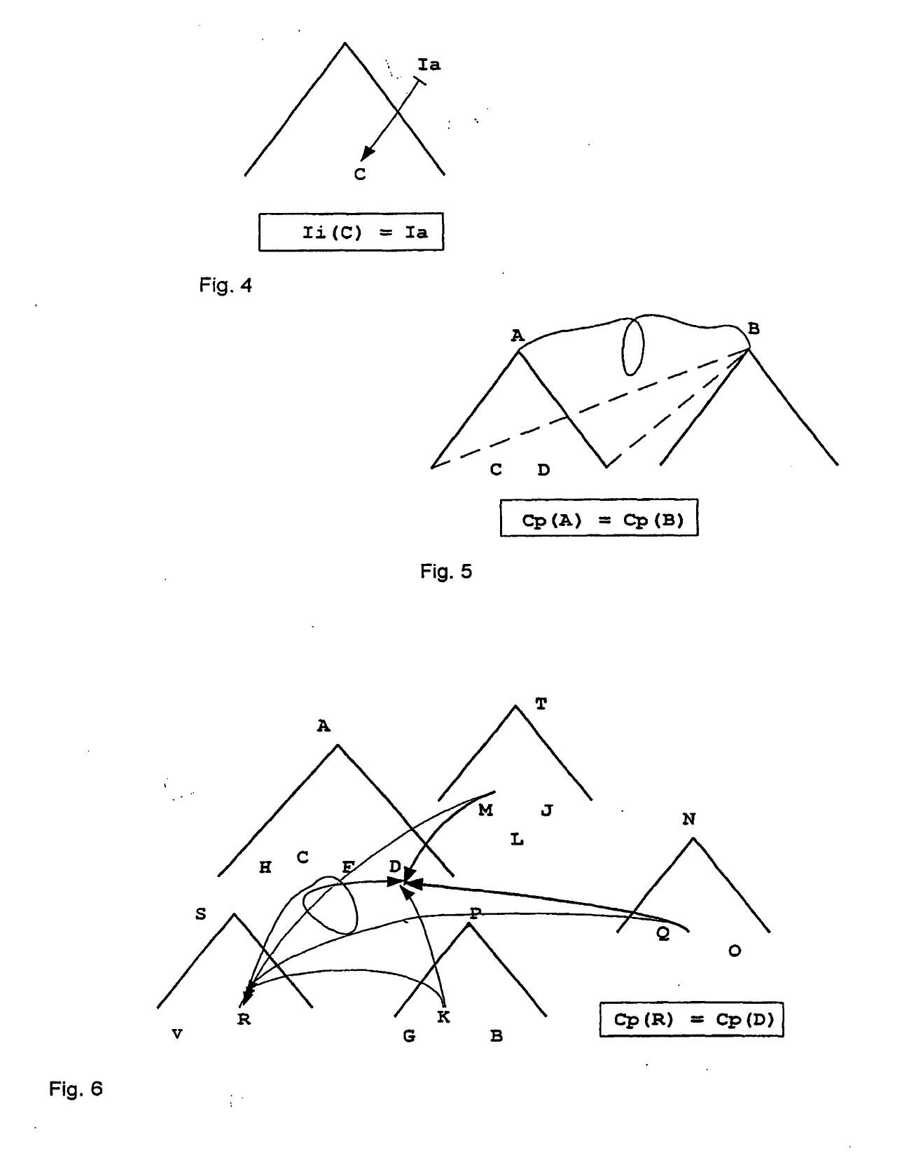

FIG. 13 Data features, ordinary case: FIGS. 4,3,2,1 represent a data sequence 1,2,3,4 in a LIFO order. The sub-sequences 43 and 21 are connected in the M=1 layer under the normative parents 3 and 1, mentioning parent 4, respectively parent 2. The complete sequence 4321 is connected in the M=2 layer under parent 21, mentioning child 43.
At any M, 2 ˆM objects are represented.
M represents ‘magification’ factor.

FIG. 14 Data features: proving the sequence 1,2,3,4
A: Data parent.
B: parent of crude objects
C: parent of children being added before their normative parent of where they are associated and from where one reads.

FIG. 15 Data features, proving the sequence 1,2,3,4,5,6,7,8.
The system requires M=3 to connect all sub-sequences of the sequence.

FIG. 16 Dimensional and relational features of the system:
A: Input argument=ordinal number of dimension or relation r
B: Input argument dimensional or relational values
C: mentioning dimensional or relational attributes of dimensional or relational points.
D: as a relation with a dimensional feature mentioning connection and is mentioned as a hand of connection (table)
E: the firt dimension value
c: (connection) corresponds to a row in a table
h: hand of connection) corresponds to a table
r: (relation of connection) corresponds to a coluum in a table
(h, r, c) corresponds to a cell in a table

### DETAILED DESCRIPTION OF PREFERRED EMBODIMENTS OF THE INVENTION

The invention relates to architectures of refering systems in computing and to systems of formation and transformation of globally valid connections of elements.

The invention provides elements and structures to connect, relate and manipulate elements. Any element alone takes no capacity and is defined as an address in one of the three or more structures, the linear or one of the two or more hierarchical, the normative or the associative, structures. The hierarchical structures represent trees. The system defines unlimited numbers of trees. In its preferred embodiment described here, the system has two trees.

In the linear structure the elements are unique elements, whereas in the tree structures the elements, normative or associative, are matching elements.

A matching element uniquely identifies the element's parent in its corresponding tree and matches the many children in the corresponding layer containing the element.

Only two matching elements, each defined in a different tree, together define the unique element defining an existing or a non-existing object. Only an existing object takes capacity.

One of the matching elements defines a unique element in the scope of its parent, which is defined by the other matching element defining the same unique element.

The equivalence of the unique element of the one to the absolute value of the matching elements of the many of one of the trees defines the corresponding, normative or associative, layer of connections of the one bi-directionally to and from the many in the tree.

The two (or more) trees connect the same one existing (parent) object bi-directionally to and from two layers of elements (of the children of the parent) in the two (or more) different trees.

The size of any existing object is half x bytes, where any layer of each tree has 2ˆx matching elements, and the linear structure has 2ˆ(x−1) unique elements.

Although all the elements are previously defined in one or even two of the three (or more) structures, most of the elements are reserved addresses of non-existing objects and as such they are only partly defined.

The three elements defining an existing object are uniquely identified by its three corresponding identifiers, the unique, the normative and the associative.

Any existing object is an associative parent as well as a normative and associative child, and consists of its three identifiers together with a private characteristic and an x bit size exclusive value. The private characteristic includes the link of the normative parent to its children together with the part of the associative identifier which is not contained in the unique identifier.

An existing normative parent object includes also its link to its children in the normative tree. The existing children in the normative tree exist also in the associative tree.

A special mechanism, enabled by the link of the normative parent of the object and by its associative parent, automatically combines for any existing or non-existing object the equivalence of its unique identifier to its two matching identifiers.

The system provides collection of one object by only its unique identifier, and also collections of many objects by only one of their matching identifiers.

The collection is done by two (or more) normative and associative, sub-systems, one of which is the leading and the other is the following and where, for the matter of the connections resulted by equalities, the objects in the following sub-system are mirror objects and only the objects in the leading sub system are the objects. The default leading sub system is the normative sub-system.

Any layer of elements of each tree is set, ready for collecting, in a sequence in the linear structure.

Only two steps of accessing an object are required for the accessing from the parent to any of its children in the two (or more) tree layers and only one such step is required for access from a child to any of its two parents. Two steps of accessing from parent to child are needed because one of the two trees is of referrng arguments through gates.

The provided visibility by these three methods of accessing covers bi-directional connections together with collecting horizontally the normative and peripherally the associative layers of connections of parents and children of the two (or more) trees. Owing to this visibility, since children of a parent of any tree are ready for collecting, children of a parent of one tree being also parents of children of the second tree, although they are spread in connections to many layers of the first tree, are ready for collecting due to them being also the children of the parents of the second tree.

The system provides several types of connections:

The ‘normative connections’ bi-directionally connect many normative children to and from one normative parent. (FIG. 1A)

The ‘sharing connections’ connect many sharing objects uni-directionally to one shared object, when the link of the sharing objects is equal to the link of a normative parent object being the shared object, so that the sharing objects share the normative children of the normative parent. If the associative tree refers by link, then the associative parents also can be shared. (FIG. 5)

The ‘associative connections’ are either ‘mentioning connections’ connecting objects, or ‘input connections’ each connecting an object to an argument. Although all associative connections refer by more then one referring arguments through gates, the distinction here between mentioning and input connections is, that the first make a tree defined by referrg to objects of the system and the second is a beginning of the first, referring to other arguments han of the first. (FIGS. 1B, 1C)

The ‘mentioning connections’ connect many mentioning objects as children bi-directionally to and from one mentioned parent object. (FIG. 1C)

The ‘input connection’ connects an input object to an input argument equal to the associative identifier of an input object. The argument of the input connection is an associative parent of the input object and is not assigned to the system by the exclusive value of its objects, when this argument is intended to be memorized, so that the input connection connects many (times the same) parent(s) to and from the one input object child. Any new normative parent of a layer of input objects is a new additional root (beginning) in the associative tree of the system, additionally to the single root of the normative tree. (FIG. 12)

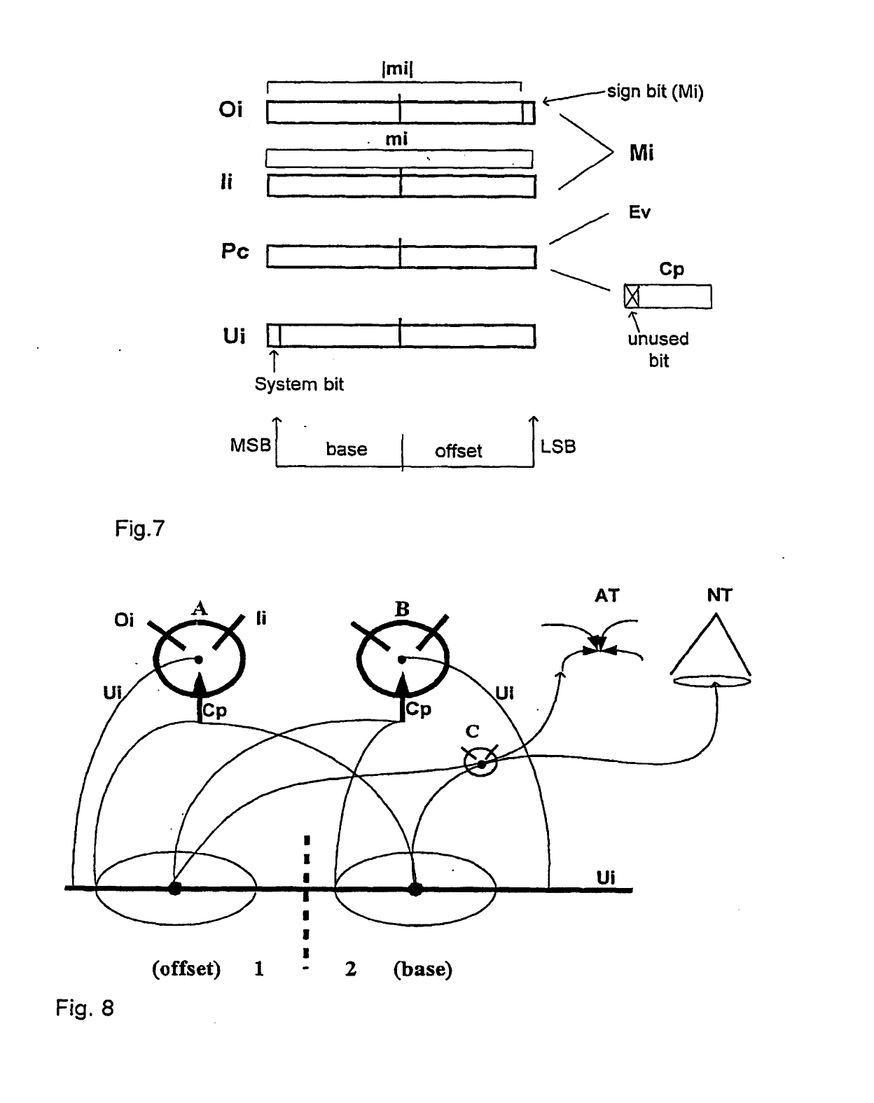

The exclusive value is distinguished by one bit from being a pointer to an object or being calculated data. (FIGS. 1G, 1H, 7)

The counter object mentions an attached object, ‘attached’ being defined as attached to the counting, where the counting uses the counter object's exclusive value and is specified by a specific counting type defined by the parent specifying the type of the counting in its layer.

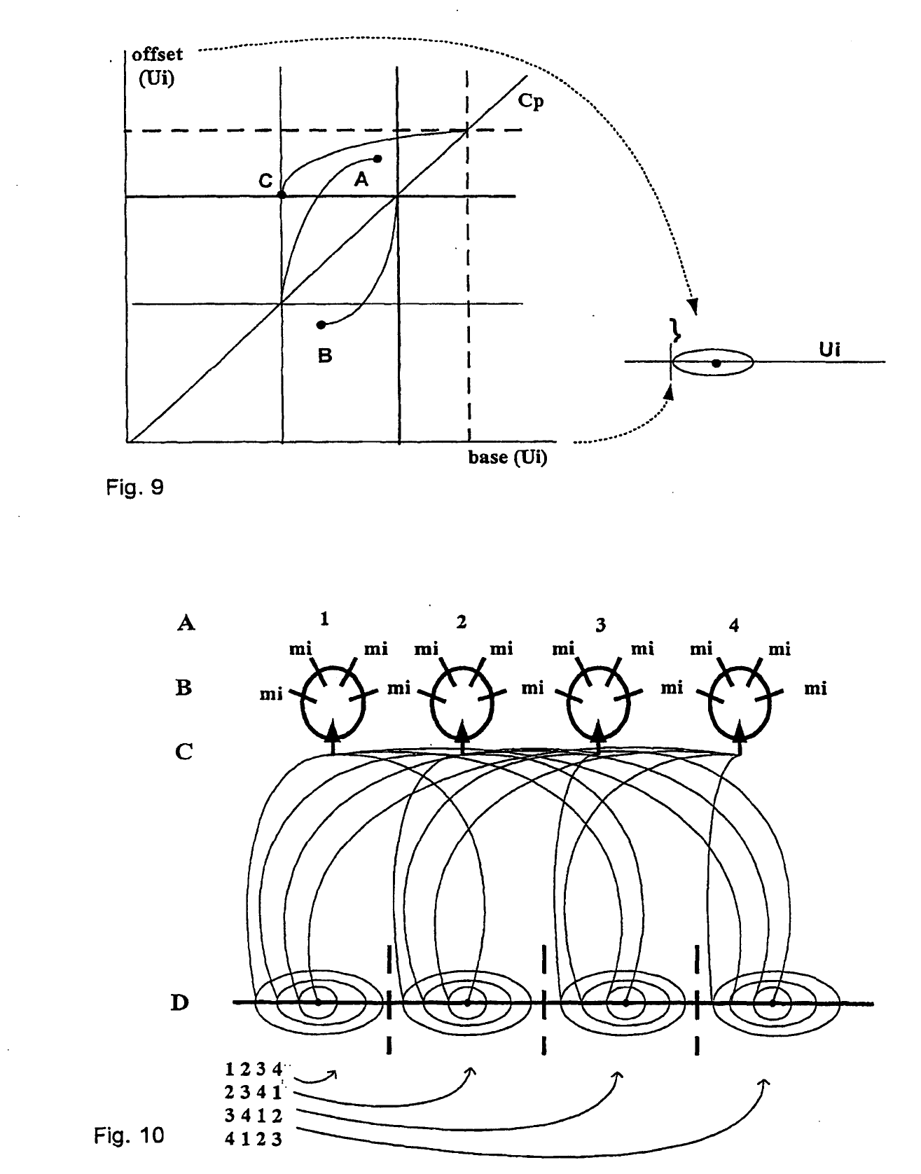

The Model of the System of the Invention (FIGS. 8-16)

Any order defining one or more elements by one element, such as the methods following the ‘Traditional Theory of Sets’ or the ‘Fuzzy Theory of Sets’ (the latter using the exclusive value as the membership value of the element), can be designed by a layer of input objects of input arguments representing the distinctions of elements included in any such set represented by the normative parent associatively connecting (‘mentioning’) the input object, which represents the distinction of this set, as an element in its containing set

The normative tree, beginning in the layer of the normative children of the input objects, will represent then all such sets, where the set of all such sets is the normative and associative child of the first input argument and the restriction of following layer by layer the steps of the definitions is achieved by following the normative tree order. All orders other than those only mentioning the input objects are out of the range of these design theories.

New beginnings (roots) and the depth in the normative tree between the mentioned and the mentioning objects are arguments of describing orders in the invention system. Both dominant theories of sets have one beginning and increase depth following their orders, while dimensional orders, i.e., have a fixed depth.

The simulation of the specification of the object is applied to its unique identifier. The simulation of a matching request is applied by the object's unique identifier and by the generalizations and specifications of the matching request. One of the two connections—the normative or the associative—specifies, and the other generalizes the simulation of the matching request applied by the object. In the system's default, the reverse being optional, the associative connection specifies and the normative generalizes. Still, the generalizations of the matched request applied to an object are independently applied to both the normative and associative parents of that object by its corresponding identifiers. The object specified by the two types of generalizations then optionally generalizes, by two types of specifications, the specific matching requests applied to some specific objects. In short, any object of the system in its preferred embodiment is required to have two parents and most every object potentially functions as a parent in two families. The number of parents required always depends on the design of the system of the invention. When it is designed with more than two trees, its objects will require to have a parent from each of the designed trees.

As long as a potential object of the system does not have both of its two (in the preferred embodiment) parents, it does not take capacity in the system and does not exist as an object, although it is partly defined. In addition every existing object is automatically assigned, and independently accessed by, a unique identifier. In the system of the invention, the object is not a record of an act of inclusion in a domain being a scope of its parent, as is the case in prior art, but-instead is a record of an act of movement between, or of a touch of, or of a contact with such domains. The recorded movement has a unique identifier and as a record creates automatically one associative domain or optionally two domains, where the movement is a direct available movement, either to or from the domains of the roots of the system or between the other domains.

The connections in the system of the invention set the order of the system. The system sets order by recording acts of movements. Except for the orders of modifications of the existing orders, the plurality of beginnings together with the fact that all the system objects are valid to refer to and to be referred by any object together with the record of the movement between the domains, which creates domains, provides any next order of the existing orders of the system.

The system of the invention also provides different times for any new definitions of its objects always requiring two definitions, with an unlimited gap of time allowed between them. Since the definition as an address is always previous to the defined, a new sense of definition is added as ‘hard’—being the last definition—and ‘soft’ being previous to the last definition. Both are required for any address defining any object.

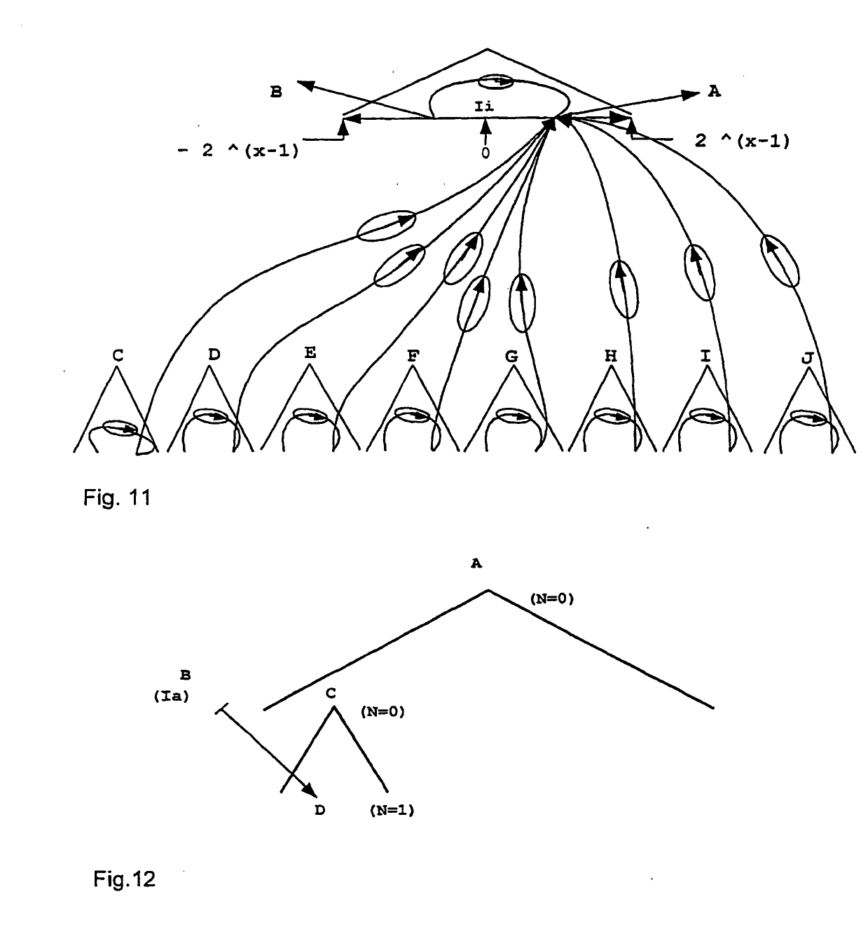

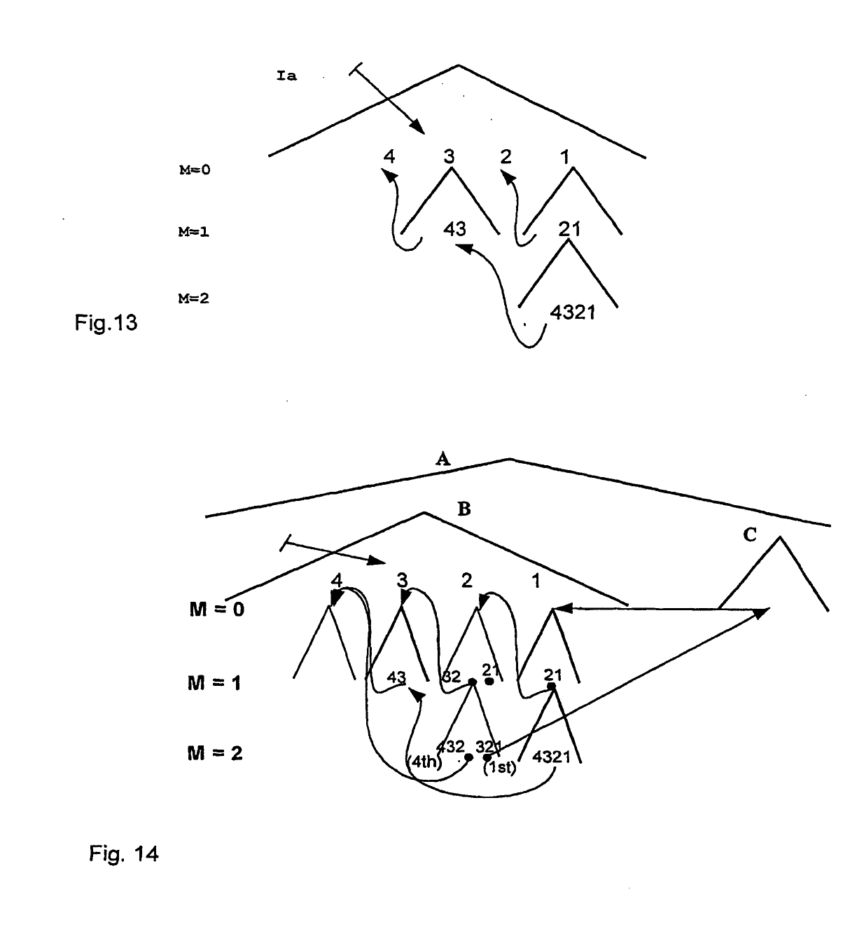

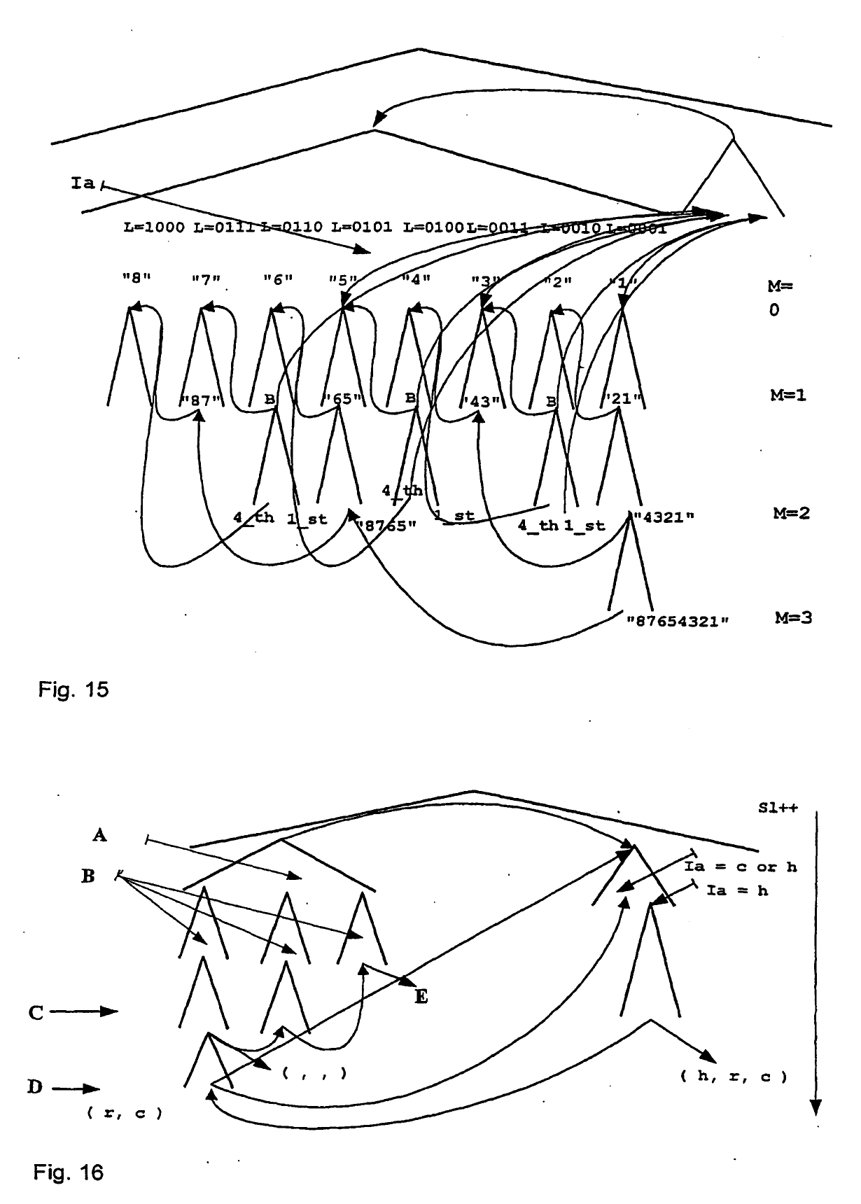

Interactive Features (FIG. 11)

The system of the invention further provides interactive features for its objects:

‘Dynamic insertion’ is a feature of reaction of any existing object to redefine the object according to its redefining condition. This feature enables to define only the change of dependencies applied to the object, instead of rebuilding the dependencies all over.

A redefined object is called ‘static’, and is redefined by the ‘dynamic(static)’ objects and by the order of the stream of the mentioning connections which begins with the dynamic(static) and remains in the same normative domain. The redefining condition of an object belongs to the enabling conditions applied to the static and to all dynamic(static) by executing the ‘exclusive value’ and the normative link of dynamic(static), where an object which is not ignored is enabled. The enabling conditions are:

if the object does not exist, it is ignored;

if its normative identifier is negative and if dynamic(it) are ignored, then ignore it also, otherwise do the redefining condition of dynamic(it);

if its normative identifier is positive, then ignore all dynamic(it) and either do its redefining condition when it is dynamic(static), or do its connections with no feature of reaction.

In the preferred embodiment of the system the associative parent has, and the normative parent does not have, a signing bit in their referred unique identifier although the associative and the normative identifiers are signed integers.

The dynamic(static) is either the object defined by the normative parent of the static and by the negative associative identifier of the static if enabled, or are the positive mentioning(static) objects in the following eight normative domains:
the ‘last alone’, there the eight domains begin, and the dynamic insertion ends if the dynamic(static) is enabled, or the ‘conditioned’: the static is under the condition of the dynamic(static) formulated by static=function(dynamic);
the ‘conditioning’: the dynamic(static) is under the condition of the static formulated by the dynamic=function(static);
the ‘former’: the dynamic(static) is added before the static;
the ‘contrary’: the dynamic(static) is added instead of the static;
the ‘latter’: the dynamic(static) is added after the static;
the ‘similar’: the dynaminc(static) is accompanying the static in the background;
the ‘lead’: the dynamic(static) is accompanying the static in the foreground.
   Orientation

The system of the invention (except for the exclusive value of its objects) can be described as a conjunction of orientations by objects, or of orientations in a space by points. The system provides conjunction of four (in the preferred embodiment) such orientations, with each orientation having its own flow or order and all the orientations cross and are encapsulated by any object. The first three orientations are non-dimensional and are allowed to continue the flow of the order to any object. The four orientations are:
the ‘Normative’ as the basic or the primary orientation providing the place for, or the condition of the other orientations;
the ‘Associative’ orientation being the occurrence of the conjunction,
the ‘Interactive’ orientation as the most recent, being the change of the conjunction,
the ‘Global’ orientation as combination or unique key of the conjunction in a linear order, containing a part of one of the first two orientations enabled by the two sub-systems of the preferred embodiment.
   Standard Level Feature of an Object

Different groups of unique identifiers of objects can be marked in the system as different ‘Standard Levels’ of use. In any normative layer all the children have the same standard levels of use. Alternatively, if the associative tree refers by the link, the layer of associative children is defined by the same link of the normative tree and the associative children thus would be effected by the standard level.

All the objects by their unique identifier and all their children by their matching identifiers are marked to belong to the same standard level and are differentiated from other standard levels of use. This provides a technique to assign objects and their children to regions specified by their applications, although they are spread in different depths. When common uses are identical, but specific uses are not necessarily identical in different such systems, the cost of information transmitted by the absolute value of one unique identifier containing any amount of layered connections of common use between the systems or of specific and common uses in one system is x−1 bit size only and the arguments between the systems of the specific use for building in one of the systems the missing parts of the transmitted information are of half x byte. This allows in many cases to transmit information without transmitting blocks of large size data. This feature can be implemented not only in local and wide area networks but also embedded in machines and hardware chips performing communications between components of machines or nodes in parallel computers and clusters.

Modifications Features

Various modifications of an existing object are provided by the system of the invention: Modification of its exclusive value; disabling or enabling dynamic insertion to it; associating it; having or sharing normative domains of objects due to the modifications of the normative link of it or of other sharing objects, creating or deleting it. A group of existing objects can be modified by the modifications of a single existing object under the provided visibility of the system. If necessary, objects only in one of the two sub systems can be modified, but this requires to check both systems in any real-time step of reading.

Any next order of any order recorded by the connected movements is available in, or can be applied to, this system, as well as between such or to such systems.

Terminology and Definitions:

The ‘normative’ is applied by the normative or ‘outer’ identifier (‘Oi’);

the ‘associative’ is applied by the associative or ‘inner’ identifier (‘Ii’);

the ‘interactive’ is applied by the dynamic insertion enabled by the object's normative identifier;

the ‘global’ is applied by the unique identifier (‘Ui’);

the exclusive value is marked by ‘Ev’

and the private characteristic by ‘Pc’. Pc includes the link of the normative parent which is the combinative pointer

marked by ‘Cp’ and the part of the Ii which is not contained in the Ui.

The object contains the following 4 attributes each of x bit size: Ui, Pc, Oi and Ev.

The input argument is marked by ‘Ia’.

An existing object is defined by having a specific unique identifier and a capacity equal to half x bytes (x being the same x as defined previously by the conjunction of the size of the object, the range of the linear addresses and the range of the number of objects in a layer of a parent).

A ‘Thing’ is one or more existing objects or is defined by one or more connections.

All Things are valid in all the system.

A ‘Void thing’ is a Thing, but not an existing object (so Void things have no capacity and no specific unique identifier).

The Unique identifier is a number, not a media location, which is searched by a binary tree of maximum x cycles of memory access (so no cost of capacity is applied to Void things and no restriction for Void things is required). A Void thing having an existing parent can also be referred exclusively by an existing object, when the object's inner identifier is equal to the inner identifier of the Void thing and when its parent's inner identifier is equal to the outer identifier of the Void thing.

Insertion is the action of turning a void thing into an object.

Things record events of connections.

A ‘System thing’ is a Thing of, or connected by, the system.

Dimensional Features (FIG. 16)

Any dimensional point as a specific combination of identifiers perpendicular to each other and set in an order of previous to next can be simulated by the system: The different perpendiculars are simulated by different domains; the inner identifiers defining certain objects in the different domains are simulated as the identifiers in the different perpendiculars; objects either are parents of specific domains, or an object can itself be a specific domain if the perpendicular is the first one; the specific domains are set in the order of the identifiers given in the dimensional point and the recording of the movements between the specific domains simulates the dimensional point combination. The dimensional perpendicularity is simulated by the restriction of the recorded movements to be only to that specific domain which simulates an identifier in the next perpendicular of the dimensional point.

Relational Features (FIG. 16)

The system of the invention can simulate relational features by a ‘pipe of connections”, defined by a line around the pipe in a length of max(h) units and in a form of a circle of which the center is a point in the axis of the pipe. The line is the pipe's revolving measurement of which any unit marked by the integer h defines a hand of connections. The hand is a table being an object extending from the pipe edge to its axis. The radius in the pipe, representing a column in any table, is marked by the integer r defining the relation of the connections from many hands to one hand. The row in any table, being parallel to the axis in the pipe, is marked by the integer c defining the connections defined by the relation r to the hand of which h=c; the cell in any table being defined by (h, r, c) contains the integer v marking non-existence of the connection
if=0; max(c)=max(h) and min(h)=min(r)=min(c)=0.

In the pipe; all the connections are differentiated by the their relations; the relation alone has no specific direction. The connections are from many hands to one hand. The connection alone has a value, has direction from a hand defining the relation of the connection and is not a dimensional connection, since it is not connected to a connection alone, but to a one-dimensional point (h) being a hand or a set of two-dimensional points (r, c), each containing a one-dimensional value (v) and is defined by the hand (h), by the relation (r) and by the connection (c). The pipe of connections is simulated in the system by the three-dimensional point (c, v, r) mentioned in the domain of the parent simulating the identifier c=h, so that the domain simulates the connected hand.

The first order of completing what constitutes a sentence can be represented by this pipe of connections, when r is defined by the predicate or by predicating, c is defined by the object and h is defined by the subject, all of the constituent.

The next orders of completing constituents can be applied by the system of the invention, but not by the pipe of connection, when the orders consist of differentiating r, c or h after being defined (i.e. the completed constituents can be divided differently than being defined) or when the orders consist of constituents being also at the position of r, c or h (i.e. for completing the sentence from its constituents and for completing the word string from its sentences and for completing a whole of word strings from its word strings and so on).

Data Features (FIGS. 12-15)

Data in the invention system is defined here where all the following conditions are maintained:
Data is a container of one or more data figures, any of which has complete capacity in different locations in the data, where the location in the data is the identifier of the data figure.
The arrangement of the data sets one or more connections in the data and results in a sequence.
One or more connections, being set by the arrangement of the data and being of the data figures or being of the sequences of the data, are the subsequences of the sequences of the data arrangement.
The sub-sequence is connected also to other sequences arranged in one or more data.
The linear arrangement of the data sets connections of sequences by connecting the previous to the next sequence and then changing the next to be the previous to its next of which the location is increased by 1, until the next is the last.

Data as an input to the system is set in a linear arrangement and optionally and additionally in dimensional arrangement where all the following conditions are maintained:
The data figures have an identical size smaller or equal to the input argument size.
The integer L marks linear location of data figures, where last data figure is marked by L=1 and first by L=maximum of data figures, so that L increases in the backward direction of the data
‘Crude’ figure is one of the data figures without its location in the data, where crude figure is Ia equal to Ii of an input object which is a ‘crude object’.
All crude objects are normative children of the crude object's parent, which is a normative child of the input data parent.
Any of the location objects mentions crude object or location object and is a normative child of crude object or of a location object.
The integer M marking magnification is the ordinal number of layers in the normative tree, where crude objects have M=0, and the integer H(M)=1/(2ˆM).
The location object(l) representing the sequence of the data of its figures from L=1−2ˆ(M+1) to L=1, is created for any M as long as H(M)>0 and for any 1=2ˆ(M+1)*H(M+1)as long as 1<L+1, as a child of the two parents, the normative being the location object (2ˆM*H(M)) and the associative being the location object (2ˆM*(H(M)+1)), if ((H(M)>0) and ((H(M )& 1) equals 1)), so then the location object (1) is the ordinary child, or if ((H(M)>1) and ((H(M & 1) equals 0)), so then the location object (1) is the complementary child, and where the complementary child is also a parent of the child of the associative parent being the location object (2ˆM*(H(M)+2)) and of the associative parent being the associative child of the associative child of the location object (2ˆM*(H(M)−1)) being normative child of the parent of the children being added before their normative parent which of their association when they are read.

The integer ‘S’ represents a sequence of S data figures, where the crude objects parent and the input data parent represents S=0, crude object represents S=1 and location object represents S equal to the sum of S of its mentioned object and of its normative parent.

‘Ordinary object’ represents input data by going to the mentioned object while collecting in a LIFO order the ordinary parents of the mentioning objects in the path until reaching the crude figure, laying out its Ii as an Ia and continuing representing input data from the first out collected ordinary parent, until there is no ordinary parent. Ui of the following distinct cases are marked by different Standard levels ‘S1’, when the cases are:
the case of the input data parent, the case of children of the input data parent,
the case of crude objects and the cases of ordinary or complementary children having identical M.

The dimensional arrangement of data sets linear arrangement of data in B dimensions, where all dimensions marked by the integer b are set in order of previous to next and where all the following conditions are maintained:
0<=b<B, where all objects of b>1 and M=0 are normative children of the input data parent and crude(b) object is associative parent of crude object(b+1).
Each b has maximum marked by max(b) and location marked integer 1,
where 0<1(b) <max(b)+1.
The data defined by 1(b) is created as linear data ending with last(b) location object.
All mentioning objects mentioning the last(b) location objects are created as linear data ending with last(last(b)) location objects.
For all b the mentioning objects mentioning the last(last(b)) location objects are created as linear data being in dimensional arrangement.
   Data Sequences and Sub-sequences

By the ordinary and the complementary cases all the data sequences being the sub-sequences (sub-intervals) of linear or dimensional data arrangement are accessed from parents to children as were created, and their children are collected by both trees, where the linear order of the sub-sequences is distinguished by the complementary children through increasing M, so all the sub-sequences are connected by their arrangement of data, so that sub-sequences are connected to the next and the previous sub-sequences for completing the data sequence, in addition to and distinct from being connected to other sequences of other data.

Using Exclusive values and/or counter objects of the data objects containing the checking marker together with ‘1’ results in equality of parts of the data in different ‘1’, where checking marker repeats when the data is accessed from the parents to the children.

Beside the connectivity performed by the data features, only m instead of 1 layers are used for defining information being in a size of 1 figures each of a size of x bits, where the size of the total information is (x/8)ˆ(2ˆm) bytes and 1=2ˆm.

Programming Features

The ‘where_in’ specifications are scopes of specifications in one or more machines, data, connections and/or data representations. An instruction is an instruction of a simulation by a thing, when the instruction is prior to the simulation by the thing. The matched request applied to a thing can be simulated directly by the thing or can also contain instructions.

The primary instruction simulates one or more instructions, each can be general having no specification of where_in and/or specific having the required specification of where_in, when the specific primary instruction is the most prior instruction and is executable, so that in addition of its being simulated it can also be executed in its where_in as required.

The programming arguments are Ev and Pc.

In the beginning of a block of instruction the programming arguments are input received from the previous block and in the end of the block they are output given to the next block, where the instruction in the block follows the order of the flow of control.

The flow of control is under the condition of the dynamic insertion of its objects and goes to the next object in the order defined by the following priority of blocks and flow of control in each block:
First block: if Ev is a pointer, go to the pointed;
Second block: if the object is a mentioning object, go to its associative parent;
Third block: if the object is a normative parent, go to its children, and if the child is an input argument, begin with zero, where this block is an instructions block, otherwise this block is a conditioning block containing a static object as the condition and their dynamic as ‘else’ of the condition;

Alternatively, to achieve a much bigger variety of the programming feature, both trees can be referred by the link.
Fourth block: if the object is an input argument, go to the bigger input argument in the normative layer.

The calling direction of instructions is from the calling block of instructions to the executable block of instructions and back to the next calling block of instructions until the simulated thing, when the simulation of the calling goes from the simulation of one by one of the many, to the simulation of the one connected by the many and is considered as having the direction from the active to the passive.

Instruction can call or be one or many primary instructions or instructions or direct simulated things.

(Note: this invention refers also to the earlier patent application “A Method for Constructing Objects in a Computing Environment” (EP 00 108 378 A). The entirety of this document is incorporated into the present document by reference. The current invention is based on the earlier one and extends it. In some cases, the terminology has evolved, since there is no prior art terminology for multi- or meta-hierarchical systems available, some terms had to be newly introduced. The main difference from the prior invention are:
1. the prior invention was restricted to two hierarchical trees, the new one is not.
2. The prior invention is a subsystem of the current system with the normative tree leading the collection of objects. The new invention has as many subsystems as there are trees.
3. The preferred embodiments of the new invention have been optimized and simplified (i.e. where the earlier system required two up-to-down steps for accessing a layer, the current invention requires just one)

The preferred system and embodiment of the system of this invention is a system of two trees only, the normative and the associative, both being referred by link, where the associative parent does have, and the normative parent does not have a signing bit in their referred unique identifier, where the system has 2 subsystems, the leading being the normative in which the Ui defines the connections of the object, where the system defines 64 standards and where all the following conditions are maintained:
1. most_left_only is defined by 32 bits of which only the most significant bit (MSB) equals one and any one of the other bits equals zero and full_most_left_only is defined by 64 bits of which only the MSB equals one and any one of the other bits equals zero.
2. The object is of 32 bytes including 4 attributes of 8 bytes each, where each is defined by its most significant 32 bits base and by its most less significant 32 bits offset and where the four are Ui and Pc being encapsulated by P_by and Oi and Ii being encapsulated by P_to.
3. The matching identifiers (Mi) of the object are Oi of the normative tree and Ii of the associative tree, both are signed integer, where their least significant bit (LSB) is a sign bit, so that when is 0, then is positive and when is 1 then is negative, where the absolute value of Mi equals Mi/2, so that when Mi is negative then equals 2*(absolute value of Mi)+1, and when Mi is positive then equals 2*(absolute value of Mi), and where (Mi and 1) equals 1 then Mi is negative, otherwise Mi is positive.
4. The combinative pointer, Cp, having 31 bits only (MSB being unused), is the link of the object to its children.
5. The private characteristic, Pc, of the object of the leading subsystem contains in its base either Cp or most_left_only if the object is not a parent, and contains of the other subsystem the exclusive value, Ev, of the object.
6. ACp is the Cp of the link of the associative parent of the object.
7. NCp is the Cp of the link of the normative parent of the object.
8. is_minus is the sign bit of the Ii of the object.
9. The most significant bit (MSB) of the unique identifier, Ui, of the object marks the subsystem of the object so that 0 marks the associative and 1 the normative, where the other bits define the unsigned integer of Ui of the object, so that
AUi is the Ui of the associative subsystem,
where base of AUi equals ACp
and offset of AUi equals (NCp*2)+is_minus
and NUi is the Ui of the normative subsystem,
where base of AUi equals NCp+most_left_only
and offset of AUi equals (ACp*2)+is_minus.
10. The conversion of Ui of associative subsystem to Ui of normative subsystem, where FUi is the converting Ui and TUi is the converted Ui is where
the base of TUi equals ((offset of FUi)/2)+most_left_only
and the offset of TUi equals ((base of FUi)/2)+(LSB of FUi),
where LSB of FUi is the most less significant bit (LSB) of FUi.
11. The conversion of Ui of normative subsystem to Ui of associative subsystem, where FUi is the converting Ui and TUi is the converted Ui is where
the base of TUi equals ((offset of FUi)/2)
and the offset of TUi equals ((base of FUi)/2)+(LSB of FUi),
where LSB of FUi is the most less significant bit (LSB) of FUi.
12. When the object is created and its Ui is set, then
its Ii is set to AP*2,
its Oi is set to NP*2
and the base of its Pc is set to most_left_only if the object is of the leading subsytem, where AP is the unsigned integer of Ui of the associative parent of the object
and NP is the unsigned integer of Ui of the normative parent of the object.

### METHODS

The following four methods are given to further describe a sample embodiment of the invention:
1. The method the_Ui receives the RUI of 8 bytes and the to_write of 1 bit arguments and then sets the global pointer P_O to the unique object of which Ui equals RUI with setting the global bit is_old to the statement equivalent to the object is found. The method returns the managing arguments of the type Ob_pile_access belonging to the object. When the method is terminate, then if to_write is true, then the object is created and its Ui is set to RUI and if to_write is true or the is_old is true, then the pointer P_O is set to the object having Ui equals RUI.
2. The method set_step_block receives the in the following order the following arguments the 4 byte base being the base of Ui of the first in a row of objects requested and the 4 byte offset being the offset of Ui of the first in a row of objects requested, and then calling the method the_Ui
   and setting global buffer of objects manageable by the argument of the type manage_collection
      including
      stop being bit which if equals one, then the row can not be found,
      left_to_do being amount of possible objects in the row which are in the buffer
      and P_O pointer in the buffer to the first object in the the row which is in the buffer
   and returns the being set argument of the type manage_collection.
   3. The method step_block_back receives the argument of the type manage_collection and returns argument of the same type of the next buffer of objects having bigger Ui.
   4. The method P_function . . . .

The general methods:

```
1. is_not_NP equals most_left_only,
  to_make equals 1,
  to_get equals 0,
  no_st equals 0,
  Is_associative_sys equlas 1,
  Is_normative_sys equals 0,
  of_default equals  0,
  of_up equals  1,
  of_class equals  2,
  of_content equals  3,
  of_list equals  4,
  of_counter equals  5,
  of_null equals  6,
  of_remove equals  7,
  of_HW equals  8,
  of_crude equals  9,
  pile_NP equals  0,
  data_NP equals  1,
  classes_NP equals  2,
  content_NP equals  3,
  list_NP equals  4,
  counter_NP equals  5,
  NULLDATA_parent equals  6,
  remove_before_NP equals  7,
  add_before_NP equals  8,
  crude_NP equals  9,
  max_M equals 32,
  and PileMAXframe equals 10.
2. The method as_signed or Ia_of or as_Mi receives the 64 bit
integer H and returns H * 2.
3. The method as_abs receives the 64 bit integer H and returns H / 2.
4. The method is_NEG receives the 64 bit integer H and returns the bit
set to the statement equvivalent to( ( H and 1 ) equals 1 ).
5. The as_Ni receives the 64 bit integer H and returns (H / 2) +
full_most_left_only.
```

The standard methods:

```
1. standard_log equals 25 and standard_log_plus_one equal 26.
2. The method set_the_standards sets the integer standard_level to 0
  and as long as standard_level is smaller then standard_max
  the method sets the two 32 bits global variables of the array marker
  marker[ standard_level ]
    to ( standard_level being left shifted standard_log bits )
  and marker[ standard_level + 1 ]
    to ( ( standard_level + 2 ) being left shifted standard_log ) − 1
  and then the standard_level to standard_level + 2.
3. The method mark_of receives the integer standard and if ( standard
and 1 ) equals one, then returns the global marker[standard] decreasing by
one after the method is terminate, otherwise the global marker[standard]
increasing by one after the method is terminate.
4. The method of_associative_sys receives the 64 bit integer H and
returns the bit set to the statement equivalent to(( H &
full_most_left_only ) equals 0 ).
5. The method st_level receives the 64 bit integer x and calling with the
argument x the method of_associative_sys, if the returned bit
equls one then st_level returns ( offset of x ) right shifted standard
log_plus_one bits, otherwise it returns ( ( base of x ) and
except_of_most_left ) right shifted standard_log bits.
```

The ‘combinate’ method of the system of the invention

The ‘combinate’ method is the method of the invention ‘combinative pointer’ and receives in the following order the following arguments:

the P_by NP being the P_by of the normative parent,
the P_by AP being the P_by of the associative parent,
the bit to_write set as a default to to_get,
the bit is_minus set as a default to zero,
the 4 byte Nst being the standard of the normative parent set as a default
to no_st,
the 4 byte Ast being the standard of the associative parent set as a default
to no_st,
and the bit associative_sys set as a default to Is_normative_sys.
The method first checks and prepares the coherence and then is applied
from the the fifth instruction. The instructions of the method are following:

The first instruction is:

```
if to_write equals zero,
then
if most significant bit (MSB) of (base of Pc of NP) equals one
  or
  most significant bit (MSB) of (base of Pc of AP) equals one,
then the method is terminate with error number 103,
otherwise go to the fifth instruction.
```

The second instructon is:

```
if ( ( (Nst equals equals −1)
  or( Nst equals ( base of Pc of NP) right shifted standard_log bits )
    and
    most significant bit (MSB) of( base of Pc of NP) equals zero
  ) )
  and
  ( (Ast equals equals −1)
  or ( Nst equals ( base of Pc of AP) right shifted standard_log bits )
    and
    most significant bit (MSB) of( base of Pc of AP) equals zero
  ) )
is false,
then the method is terminate with error number 103.
```

The third instruction is:

```
if( most significant bit (MSB) of( base of Pc of NP) equals one
  and
  Nst is not equal no_st
  )
is false, then go to the fourth instruction,
otherwise call with the arguments NP and bit being set to zero the method
the_Ui and then if ( is_old equals one
    and
    most significant bit (MSB) of( base of the Pc of object pointed by
    P_O ) equals one
    )
  is false, then the method is terminate with error number 103,
  otherwise
  set
  the base of Pc of NP
    to the return argument of the method mark_of called with the
  argument Nst and then the base of Pc of object pointed by P_O
    to base of Pc of NP.
```

The fourth, instruction is:

```
if( most significant bit (MSB) of( base of Pc of AP) equals one
  and
  Ast is not equal no_st
  )
is false, then go to the fifth instruction,
otherwise call with the arguments AP and bit being set to zero the method
the_Ui and then if ( is_old equals one
    and
    most significant bit (MSB) of( base of the Pc of object pointed by
    P_O ) equals one
    )
  is false, then the method is terminate with error number 103,
  otherwise
  set
  the base of Pc of AP
    to the return argument of the method mark_of called with the
    argument Nst
  and then the base of Pc of object pointed by P_O
    to base of Pc of AP.
```

The fifth instruction is:

```
initiate
  the 8 byte variables
  AUi so that
  its base is set to the base of Pc of Ap
  and its offset is set to ( the base of Pc of Np ) * 2 + is_minus
  and NUi so that
  its base is set to ( the base of Pc of Np ) + most_left_only
  and its offset is set to ( the base of Pc of Ap ) * 2 + is_minus.
```

The sixth instruction is:

```
if ( to_write equals one ),
  then go to the seventh instruction,
otherwise
  if ( associative_sys equals one),.
  then call with the arguments AUi and bit being set to to_write the
  method the_Ui,
  otherwise call with the arguments NUi and bit being set to to_write the
method the_Ui and the method is teminate.
```

The seventh instruction is:

```
  call with the arguments AUi and bit being set to to_write the
  method the_Ui
  and then if ( is_old equals one )
  then call with the arguments NUi and bit being set to to_write the
  method the_Ui
  otherwise
  set the Ii of the object pointed by P_O to AP * 2
  and set the Oi of the object pointed by P_O to NP * 2
  and then call with the arguments NUi and bit being set to to_write the
  method the_Ui
  and then set the Ii of the object pointed by P_O to AP * 2
  and set the Oi of the object pointed by P_O to NP * 2
  and set the base of Pc of the object pointed by P_O to most_left_only.
(End of the combinate method)
```

The method collection_of receives in the following order the following arguments:

```
the bit associative_sys,
the object tHis,
the integer max,
and the integer function
and then if ( the most significant bit (MSB) of( base of Pc of tHis )
equals one ), then the method returns max
otherwise if (associative_sys equals zero),
then the method sets the base of Pc of tHis to the base of Pc of tHis +
most_left_only and then the method initiates
object of the type manage_collection,
  so that it is set to the return argument of the method set_step_block
  called with the arguments base of Pc of tHis and zero
and then if stop of the object equals zero,
then
as long as the ( base of Ui of the object pointed by P_O of the object
      equals
      the base of Pc of tHis
      and max decreased by one is not equal zero
      )
  doing the following instructions:
  first instruction of
  calling with the following arguments and the following order
  function , pointer to object and associative_sys
    the method P_function,
  second instruction of
  if left_to_do of object is bigger then zero, then
  moving the pointer to object back one step and decreasing the
  left_to_do of the object, otherwise setting the object to
  the return argument of the method step_block_back called with the
  argument object and then if the stop of the object equals one, then the
  method returning max.
The method returns max when it is terminate after its loop fails.
(End of the method collection_of)
```

The method old_under receives in the following order the following arguments:

```
the P_by NP being the P_by of the normative parent,
the P_by AP being the P_by of the associative parent,
the bit is_minus set as a default to zero
and the bit associative_sys set as a default to Is_normative_sys
and then call with the following arguments and the following order
  NP, AP ,bit set to zero, is_minus, no_st, no_st and associative_sys
    the method combinate,
and returns the P_by of the object pointed by P_O.
(End of the method old_under)
```

The method of input_argument under receives in the following order the following arguments:

the P_by NP being the P_by of the normative parent,
the P_by Ia being the P_by of the input argument parent
and the bit is_minus set as a default to zero
and then sets the base of the Pc of the Ia to the offset of the Ui of the Ia
and then call with the following arguments and the following order
NP, Ia ,bit set to zero and is_minus the method combinate,
and returns the P_by of the object pointed by P_O.
(End of the of_input_argument_under method)

The method new_under receives in the following order the following arguments

```
the P_by NP being the P_by of the normative parent,
the P_by AP being the P_by of the associative parent,
the 4 byte Nst being the standard of the normative parent set as a
default to −1,
the 4 byte Ast being the standard of the associative parent set as a
default to −1,
the bit is_minus set as a default to zero
and the 4 byte Cst being the standard of object as a default to −1,
and then call with the following arguments and the following order
  NP, AP ,bit set to one, is_minus, Nst and Ast
    the method combinate,
and then if ( ( the most significant bit (MSB) of base of Pc of the
object pointed by P_O )
      equals one
      and
      Cst > −1
      ),
    then set the base of Pc of object pointed by P_O
      to the return argument of the method mark_of called with the
argument Cst and then returns the P_by of the object pointed by P_O.
(End of the method new_under)
```

The method new_of receives in the following order the following arguments:

```
the P_by AP being the P_by of the associative parent,
the 4 byte Nst being the standard of the normative parent set as a
default to −1,
the 4 byte Ast being the standard of the associative parent set as a
default to −1,
the bit is_minus set as a default to zero
and the 4 byte Cst being the standard of object as a default to −1,
and then call with the following arguments and the following order
  P_by of the object pointed by P_O, AP ,bit set to one, is_minus,
  Nst and Ast
    the method combinate,
and then if ( ( the most significant bit (MSB) of base of Pc of the object
pointed by P_O )
      equals one
      and
      Cst > −1
      ),
    then set the base of Pc of object pointed by P_O
      to the return argument of the method mark_of called with the
argument Cst and then returns the P_by of the object pointed by P_O.
(End of the method new_of)
```

The method new_input_argument_under receives in the following order the following arguments:

```
the P_by NP being the P_by of the normative parent,
the P_by Ia being the P_by of the input argument parent,
the 4 byte Nst being the standard of the normative parent set as a
default to −1,
the bit is_minus set as a default to zero
and the 4 byte Cst being the standard of object as a default to −1,
and then sets the base of the Pc of the Ia to the offset of the Ui of the Ia
and then call with the following arguments and the following order
  NP, Ia ,bit set to one, is_minus, Nst and no_st
    the method combinate;
and then if ( ( the most significant bit (MSB) of base of Pc of the objcet
pointed by P_O )
      equals one
      and
      Cst > −1
      ),
    then set the base of Pc of object pointed by P_O
      to the return argument of the method mark_of called with the
argument Cst and then returns the P_by of the objcet pointed by P_O.
(End of the method new_input_argument_under)
```

The method install_Pile

The instructions of the method are following:

```
The first instruction is
Call the method set_the_standards
and then initiate two objects,
  one of which Ui = zero and the other of which
  Ui = full_most_left_only,
  so that their Oi = zero,Ii = zero and Pc = zero
and then set the pointer P_O pointing to the object of which
Ui = full_most_left_only
and then set the base of Pc of object pointed by P_O
  to the return argument of the method mark_of called
  with the argument of_default.
The second instruction is
Initiate the 2 byte variable last_frame, so that last_frame is set to zero
and then initiate the P_by global variables of an array in the
size of PileMAXframe named frame
and then set frame[ last_frame ] to P_by of the object pointed by P_O
and then initiate the P_by variable a_a
and then set Ui of a_a to 4
and then set frame[ last_frame ] to
  the return argument of the method new_input_argument_under
  called with the following arguments and the following order
      frame[ last_frame ] , a_a , of_default ,
      bit set to zero and of_default
and then set last_frame to last_frame + 1
and then set frame[ last_frame ] to
  the return argument of the method new_input_argument_under
  called with the following arguments and the following order
      frame[ pile_NP ], frame[ pile_NP ], of_default, of_default ,
      bit set to zero and of_up
and then set last_frame to last_frame + 1
and then initiate the P_by variable up , so that up is
set to frame[data_NP ]
and then as long as ( last_frame < PileMAXframe)
set frame[ last_frame ] to
  the return argument of the method new_under
  called with the following arguments and the following order
      up,frame[ last_frame −1] , of_up , last_frame−1 ,
      bit set to zero and last_frame
  and last_frame to last_frame + 1.
(End of the method install_Pile)
```

The following methods are derived from C language

The method write_data receives in the following order the following arguments:

The pointer to 1 byte figure and the 4 bytes byte_size.

The first instruction is:

initiate
the 4 bytes variable Location set to 1,
the 4 bytes variable open set to 0,
the 4 bytes variable M_bits,
the 4 bytes variable M_bits_or
the 1 byte variable M,
the 1 byte variable last_M set to 0,
the 1 byte variable of_st set to of_crude,
the pointer to 8 byte figureS,
the P_by variable crude_figure,
the P_by variable crude_data_NP set to frame[crude_NP ]
the array in the size of max_M of P_by variables prev_ordin_NP,
the array in the size of max_M of P_by variables ordin_NP,
the array in the size of max_M of P_by variables compl_NP,
the P_by variable HW,
the P_by variable HW_parent set to frame[add_before_NP],
the P_by variable last_ordin,
the P_by variable last_compl,
the bit to_positate set to zero.

The second instruction is:

```
set crude_figure.Ui to 0
  figure to figure + byte_size
  and then figureS to figure being formed as pointer to 8 bytes.
```

The third instruction is:

```
for ( ; Location <= byte_size; Location++, of_st = of_crude )
{if(!((Location−1)&7)) figureS−−;//txt
crude_figure.Ui.C[0] = figureS->C[ 7 − ( ( Location − 1 ) & 7 ) ];
last_ordin =
new_input_argument_under
  ( crude_data_NP, crude_figure, of_crude,to_positate, of_crude+1);
M = 0;
M_bits = 1;
M_bits_or = 0 ;
if ( !( Location & 1 )) do
{of_st++;
  last_compl = last_ordin;
  last_ordin =
  new_under(ordin_NP[M],last_ordin,of_st,of_st,
  to_positate,of_st+1);//S=1,ordinary
open \hat{ }= M_bits;
M_bits_or += M_bits ;
if ( ( Location > ( M_bits <<= true )) && ( ! ( Location &
M_bits_or )))
{P_by between = new_under(compl_NP[M],ordin_NP[M],
of_st,of_st,to_positate,of_st+1);
  new_of(last_compl,of_st+1);
  HW = new_under( HW_parent, prev_ordin_NP[M], of_HW ,
  of_st,to_positate,of_HW );
  new_under(between,HW,of_st+1,of_HW);
}
compl_NP[M] = last_compl;
HW = new_under( HW_parent, ordin_NP[M], of_HW ,of_st,
to_positate,of_HW );
new_under(compl_NP[M], HW, of_st);//,of_HW); //S=1,compl,HW
M++;
} while ( !( Location & M_bits ) );
if ( Location < byte_size )// else belongs to the remaineS
{prev_ordin_NP[M]=ordin_NP[M];
ordin_NP[M] = last_ordin;
if ( last_M < M )last_M = M;
open \hat{ }= M_bits; //for the remaineS
}}
```

The fourth instruction is

```
if(M < last_M )
  {for( Location−−, last_M++, M++; M < last_M; M++ )
  {M_bits_or += M_bits;
  M_bits <<= true;
  last_compl = last_ordin;
    of_st = (short)(of_crude + 1 + M );
    if ( open & M_bits )
      last_ordin =
      new_under(ordin_NP[M],last_ordin,of_st,
            (last_ordin.Pc.D.base>>25), to_positate,of_st+1);
  if ( ( Location > (M_bits )) && ( ! (Location & M_bits_or )))
  {P_by between=new_under(compl_NP[M],ordin_NP[M],
  of_st,of_st,to_positate,of_st+1);
  new_of(last_compl,of_st+1);
  new_under(between,HW,of_st+1,of_HW);
  }
  compl_NP[M] = last_compl;
  HW = new_under( HW_parent, ordin_NP[M], of_HW ,of_st,
  to_positate,of_HW );
  new_under(last_compl, HW);
}}
return (last_ordin);
(End of the method write_data)
```

The method read_dat receives in the following order the following arguments
the 8 bytes variable last_where,
the 8 bytes variable operate,
the pointer to 1 byte figures,
the 4 bytes max_size
and the bit show.

The first instruction is:

initiate
the 8 bytes variable N_last_where set to last_where.

The second instruction is:

```
if( of_associative_sys( last_where ) )
  {N_last_where.H=last_where ;
  last_where = (as_normative_sys(N_last_where )).H;
}
```

The third instruction is:

```
initiate
  the 8 bytes array of variables in size max_M named NP,
  the 8 bytes variable crude_data_NP set to frame[crude_NP ].Ui,
  the pointer to 8 bytes variable b8_figures set to figures being
  formed as pointer to 8 bytes,
  the 8 bytes Ii,
  the 2 bytes variable LIFO_id set to 0,
  the variable object in the type of the global object pointed by
  the pointer P_O,
  and the 4 bytes variable outSIZE set to 0.
```

The fourth instruction is:

```
the_Ui(last_where, false );
if (!is_old)
{*figures = ‘\0’;
  return(0);
}
else
  if(show&& of_crude > st_level(P_O->by.Ui) )
    the_Ui(as_Ni(P_O->to.Ii.H), false );
  if( of_list >= st_level(P_O->by.Ui) )
    {*figures = ‘\0’;
    return (outSIZE);
    }
```

The fifth instruction is:

```
if ( is_old )
  object = *P_O;
else
  terminate with error number 25
if is_NEG(object.to.according)
        react_object(object);
else
  {object.to.according = as_Ni(object.to.according);
  Ii.H = as_Ni(object.to.Ii.H);
  if( of_null == st_level(object.by.Ui) )
    the_Ui( Ii.H, false );
  else
    {if ( object.to.Oi.H == crude_data_NP)
      {if ( outSIZE >= max_size )return (outSIZE);
    else
    {*figures = Ii.C[0];
      figures++;
      outSIZE++;
      if ( LIFO_id )
        the_Ui( NP[ −LIFO_id], false );
      else
        {*figures = ‘\0’;
        the_Ui( object.by.where, false );
        return (outSIZE);
    }}}
    else
      {if( of_HW == st_level(Ii) )
        {the_Ui(Ii.H, false );
        NP[ LIFO_id++ ] = as_Ni(P_O->to.Ii.H);
        the_Ui(object.to.according, false );
      }
      else
      {if(of_counter < st_level(object.to.Oi))
        NP[ LIFO_id++ ] = object.to.according;
      the_Ui( Ii.H , false );
  }}}
go to the fifth instruction.
(End of the method read_dat)
```

Some sample embodiments of functions in the C programming language are attached as an Appendix. These sample embodiments serve to demonstrate the use of the previous teachings. The full sample embodiment of the system is given as preferred embodiment in a C language program under the following headers: Piletype_h, pileglobal_h and pile_c.

It can thus be seen that the invention can be used for constructing and referring objects in a computing environment in a variety of ways. The particulars contained in the above description of sample embodiments should not be construed as limitations of the scope of the invention, but rather as exemplifications of preferred embodiments thereof. A wide range of variations are possible and will be readily apparent to persons skilled in the art. Accordingly, the scope of the invention should be determined not by the embodiments illustrated, but by the appended claims and their legal equivalents.

1-14. (canceled)

15. The method of claim 14, wherein the object address of said third attribute is equivalent to the number equal to ((‘insertion ordinal number’ minus one) multiplied by (the equivalent number of the size of the scale including said first attribute )) plus (the absolute value of the equivalent number of said object address of said third attribute), when said third attribute equivalent number is equivalent to the complex number equal to said ‘insertion mark’ multiplied by said absolute value.

16. The method of claim 14, wherein the second attribute relating objects to a ‘folder object’ constitutes an hierarchical layer of the objects having identical said second attribute and identical said ‘insertion ordinal number’.

17. The method of claim 16, wherein said objects have said fourth attribute.

18. The method of claim 17, wherein the object address of said third attribute is equivalent to the number equal to ((‘insertion ordinal number’ minus one) multiplied by (the equivalent number of the size of the scale including said first attribute)) plus (the absolute value of the equivalent number of said object address of said third attribute), when said third attribute equivalent number is equivalent to the complex number equal to said ‘insertion mark’ multiplied by said absolute value and with different ‘insertion ordinal number’, by the order of said ‘insertion ordinal number’.

19. The method of claim 18, where an ‘alternative folder object’ has said first attribute equivalent number equal to the absolute value of the number equivalent to said third attribute of objects being a layer of said different hierarchical form of said objects next to said ‘alternative folder object’.

20. The method of claim 19, marking the number equivalent to said first attribute, indicating whether or not said attribute is of the object included in the hierarchical form.

21. The method of claim 20, wherein objects which are in a state of being input to, or being output of, or being not connected with, said structure.

22. The method of claim 20, using precedence over said ‘folder object of said hierarchical form and wherein said ‘insertion ordinal number’ is bigger than one and of which said second attribute is equivalent to said first attribute of said ‘folder object’.

23. (canceled)

24. The method of claim 12, wherein said objects have an identical said second attribute, when different connected said objects having said fourth attribute identical to said fourth attribute of said ‘folder object’.

25. The method of claim 13, further comprising using additional generic attribute/s alternatively or together with one or more of the four generic said attributes, to insert other than, or additional to, the connections corresponding to the use of the four generic said attributes.

26. The method of claims 25, 24, 19, 17 or 12, wherein when said object, its said attributes and said connection/s are of the type of the next orders of activities, when insertion of said next order is an insertion into interrupted continuous activity being the previous order, when the first order is a continuous activity of an order empty of activities, when every insertion interrupting continuous activity creates the next, new higher order, when any order is a connection which enables unique identification of all of its objects, when any continuous activity is a method of accessing said object/s of said order, and when interrupting said continuous activity is a method/s of accessing other than said object/s.

27. The method of claim 26, further comprising constructing or connecting objects having the same lifetime in different scopes of order.

29. The method of claim 28 with said arguments functioning also in different said lifetime.
